(19) United States
(12) Patent Application Publication
(10) Pub. No.: US 2025/0074755 A1
(43) Pub. Date: Mar. 6, 2025

(54) INDUSTRIAL VEHICLE

(71) Applicant: KABUSHIKI KAISHA TOYOTA JIDOSHOKKI, Kariya-shi (JP)

(72) Inventor: Hirokazu KISHIDA, Kariya-shi (JP)

(73) Assignee: KABUSHIKI KAISHA TOYOTA JIDOSHOKKI, Kariya-shi (JP)

(21) Appl. No.: 18/817,752

(22) Filed: Aug. 28, 2024

(30) Foreign Application Priority Data
Aug. 30, 2023 (JP) 2023-139637

(51) Int. Cl. B66F 9/14

(52) U.S. Cl. CPC B66F 9/146; B66F 9/148

(57) ABSTRACT

An industrial vehicle includes a side shift mechanism, a distance sensor provided on a side surface of at least one of the pair of forks in the horizontal direction and configured to detect a distance from the side surface to a detection object; and a control unit configured to control a side shift operation by the side shift mechanism based on a detection result of the distance sensor. The control unit stores an initial value of a distance between a side surface of the fork and an inner wall surface when the side shift operation by the side shift mechanism is started, and stops the side shift operation by the side shift mechanism when the distance between the side surface of the fork and the inner wall surface has varied from the initial value during execution of the side shift operation by the side shift mechanism.

### TECHNICAL FIELD

The present disclosure relates to an industrial vehicle.

### BACKGROUND

For example, Japanese Unexamined Patent Publication No. 2021-143039 describes a forklift including a side shift device. The side shift device described in Japanese Unexamined Patent Publication No. 2021-143039 includes a lift bracket that moves up and down along a mast, a backrest that is provided on the lift bracket and to which a fork is attached, and a side shift mechanism that side shifts the fork in a horizontal direction (e.g., a width direction of a vehicle body).

### SUMMARY

When a cargo is loaded on a cargo bed or the like of a truck by the industrial vehicle described above, a method of arraying pallets so as not to generate a gap between the pallets by abutting the adjacent pallets into contact with each other by the side shift mechanism is adopted. By eliminating the gap between the pallets, the utilization efficiency of the space of the cargo bed can be enhanced, and the shaking of the cargo due to vibration or the like during transportation can be suppressed. On the other hand, in the scene of loading the cargo, when a side shift amount becomes excessive in a case of automatically performing the side shift operation of the fork, it is conceivable that the pallet being loaded may hit another pallet that is already loaded. In this case, a frictional force when the pallet slides on the fork or a reaction force against a force by which the fork presses an inner wall surface of the pallet after the pallet has hit another pallet is applied to the fork, and a load may be applied to a fork-side mechanism (fork itself, a hydraulic cylinder for side shift, etc.).

The present disclosure has been contrived to solve the above problems, and an object of the present disclosure is to provide an industrial vehicle capable of suppressing an excessive load from being applied to a fork-side mechanism during a side shift operation.

### Solution to Problem

An industrial vehicle according to one aspect of the present disclosure is an industrial vehicle including a load handling device including a pair of forks and performs load handling by inserting the pair of forks into an insertion hole of a pallet, the industrial vehicle including a side shift mechanism configured to side shifts positions of the pair of forks in a horizontal direction; a distance sensor provided on a side surface in the horizontal direction of at least one of the pair of forks and configured to detect a distance from the side surface to a detection object; and a control unit configured to control a side shift operation of the pair of forks by the side shift mechanism based on a detection result of the distance sensor. The control unit stores an initial value of the distance between the side surface of the fork and an inner wall surface defining the insertion hole when the side shift operation by the side shift mechanism is started, and stops the side shift operation by the side shift mechanism when the distance between the side surface of the fork and the inner wall surface varies from the initial value during execution of the side shift operation by the side shift mechanism.

In this industrial vehicle, the stop of the side shift operation by the side shift mechanism is determined by the relationship between the distance between the side surface of the fork and the inner wall surface of the pallet and the initial value of the distance. During the side shift operation, both the fork and the pallet shift in the horizontal direction during a period from the start of the side shift operation until the pallet and the loaded pallet abut on each other. Therefore, in the above period, the distance detected by the distance sensor does not vary from the initial value. On the other hand, after the pallet and the loaded pallet or the like abut on each other, only the fork slides in the insertion hole in the horizontal direction, and thus the distance detected by the distance sensor varies from the initial value. Therefore, when the side shift operation is executed, the side shift operation is stopped in a case where the distance between the side surface of the fork and the inner wall surface of the pallet varies from the initial value, so that sliding of the fork in the insertion hole can be quickly detected. As a result, the frictional force when the pallet slides on the fork or the reaction force against the force by which the fork presses the inner wall surface of the pallet after the pallet has hit another pallet can be prevented from being applied to the fork. As a result, the excessive load can be suppressed from being applied to the fork-side mechanism during the side shift operation.

The distance sensors may be provided on respective side surfaces of the pair of forks in directions opposite to each other. In this case, sliding of the fork in the insertion hole can be accurately detected.

The control unit may stop the side shift operation by the side shift mechanism in a case where a distance detected by the distance sensor of one fork becomes larger than the initial value and a distance detected by the distance sensor of the other fork becomes smaller than the initial value. After the pallet being loaded abuts on the loaded pallet or the like, the pallet being loaded slides in one direction in the horizontal direction in the insertion hole. At this time, with sliding, a distance between the side surface of one fork and the inner wall surface of the pallet increases, and a distance between the side surface of the other fork and the inner wall surface of the pallet decreases. Therefore, by providing the distance sensors on the respective side surfaces of the pair of forks in the directions opposite to each other and stopping the side shift operation as described above, sliding of the fork in the insertion hole can be accurately detected.

The distance sensor may include a first distance sensor located on a basal end side of the fork and a second distance sensor located on a distal end side of the fork. In this case, sliding of the fork in the insertion hole can be accurately detected.

The control unit may stop the side shift operation by the side shift mechanism when one of distances detected by the first distance sensor and the second distance sensor varies from the initial value. In this case, by stopping the side shift operation as described above, sliding of the fork in the insertion hole can be detected more accurately.

The control unit may stop the side shift operation by the side shift mechanism when both of distances detected by the first distance sensor and the second distance sensor vary from the initial value. When the fork is inserted into the insertion hole of the pallet, it can be assumed that the fork is inserted obliquely with respect to an extending direction of the insertion hole. In this case, it is conceivable that a part of the pallet being loaded abuts on the previously loaded pallet, and then another part abuts on the loaded pallet. Therefore, according to the control as described above, when the fork is inserted obliquely with respect to the extending direction of the insertion hole, the side shift operation can be stopped at the time point the pallet being loaded abuts on another loaded pallet. Therefore, the excessive load can be suppressed from being applied to the fork-side mechanism during the side shift operation while arranging the pallet being loaded without a gap with respect to the loaded pallet.

The control unit may stop the side shift operation by the side shift mechanism when a predetermined time has elapsed after one of distances detected by the first distance sensor and the second distance sensor has varied from the initial value. According to such control, by setting the predetermined time in consideration of a speed of the side shift operation, the excessive load can be suppressed from being applied to the fork-side mechanism during the side shift operation while arranging the pallet being loaded without the gap with respect to the loaded pallet.

The control unit may stop the side shift operation by the side shift mechanism in a case where a distance detected by the first distance sensor becomes equal to a distance detected by the second distance sensor after one of the distances detected by the first distance sensor and the second distance sensor has varied from the initial value. When the fork is inserted obliquely with respect to the extending direction in the insertion hole, as described above, the part of the pallet being loaded abuts on the previously loaded pallet. At this time, the distance detected by one distance sensor located closer to the part varies from the initial value. Thereafter, when the other portion abuts on the loaded pallet, the distances detected by both distance sensors become equal. Therefore, according to the control as described above, when the fork is inserted obliquely with respect to the extending direction of the insertion hole, the side shift operation can be stopped at the time point the pallet being loaded abuts on another loaded pallet. Therefore, the excessive load can be suppressed from being applied to the fork-side mechanism during the side shift operation while arranging the pallet being loaded without the gap with respect to the loaded pallet.

The distance sensor may be provided on a side surface of the pair of forks facing the counterpart fork. In this case, the distance sensor can be prevented from colliding with the inner wall surface of the pallet with the side shift operation. Therefore, damage to the distance sensor can be prevented.

The pair of forks may be each provided with a bracket with a window. The bracket with the window may be provided on the side surface such that the distance sensor is exposed from the window. In this case, the distance sensor can be protected by the bracket while easily realizing the configuration in which the distance sensor is provided on the side surface.

### BRIEF DESCRIPTION OF THE DRAWINGS

FIG. 1 is a side view illustrating an example of an industrial vehicle of the present disclosure;

FIG. 2 is a perspective view schematically illustrating a state when the industrial vehicle performs load handling;

FIG. 3 is a block diagram illustrating a functional configuration of the industrial vehicle illustrated in FIG. 1;

FIG. 4 is a perspective view illustrating a configuration of a fork;

FIG. 5 is a cross-sectional view schematically illustrating a configuration of the fork and a pallet;

FIG. 6 is a cross-sectional view schematically illustrating a configuration of the fork and the pallet;

FIG. 7 is a flowchart illustrating an example of an operation of the industrial vehicle;

FIG. 8 is a flowchart illustrating an example of a control of the side shift operation;

FIG. 9 is a cross-sectional view schematically illustrating a configuration of the fork and the pallet;

FIG. 10 is a cross-sectional view schematically illustrating a configuration of the fork and the pallet;

FIG. 11 is a flowchart illustrating another example of a control of the side shift operation; and

FIG. 12 is a flowchart illustrating another further example of a control of the side shift operation.

### DETAILED DESCRIPTION

Hereinafter, a preferred embodiment of an industrial vehicle according to one aspect of the present disclosure will be described in detail with reference to the drawings.

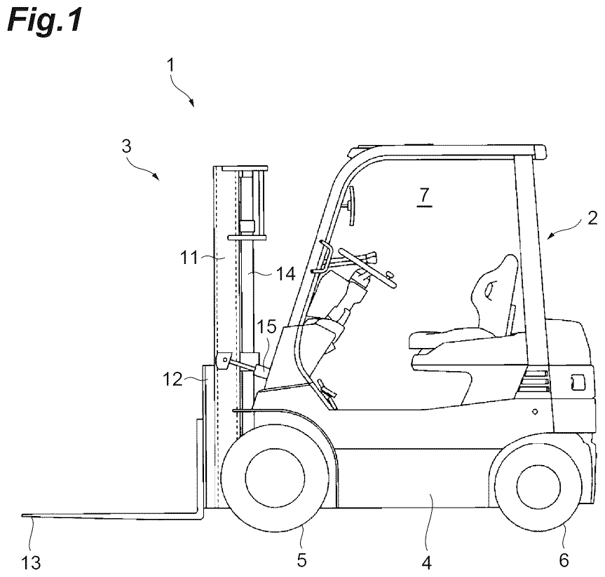

First, a configuration of an industrial vehicle 1 according to the present disclosure will be described with reference to FIG. 1. FIG. 1 is a side view illustrating an example of the industrial vehicle 1. As illustrated in FIG. 1, the industrial vehicle 1 includes a traveling device 2 and a load handling device 3 disposed on the front side of the traveling device 2 and including a pair of forks 13.

The traveling device 2 includes a vehicle body 4, front wheels 5 which are a pair of driving wheels disposed at a front portion of the vehicle body 4, and rear wheels 6 which are a pair of steering wheels disposed at a rear portion of the vehicle body 4. The vehicle body 4 is provided with a driver's cab 7 constituted by a frame including a head guard. In the driver's cab 7, a lift operation lever used for operating a lift cylinder 14, a tilt operation lever used for operating a tilt cylinder 15, a steering wheel for steering the industrial vehicle 1, and the like are disposed. In addition, the traveling device 2 includes a traveling motor that rotates the front wheels 5 and a steering motor that rotates the steering wheel shaft of the industrial vehicle 1 to steer the rear wheels 6. In the industrial vehicle 1, the traveling motor rotates the front wheels 5, and the steering motor steers the rear wheels 6, thereby realizing traveling by the traveling device 2.

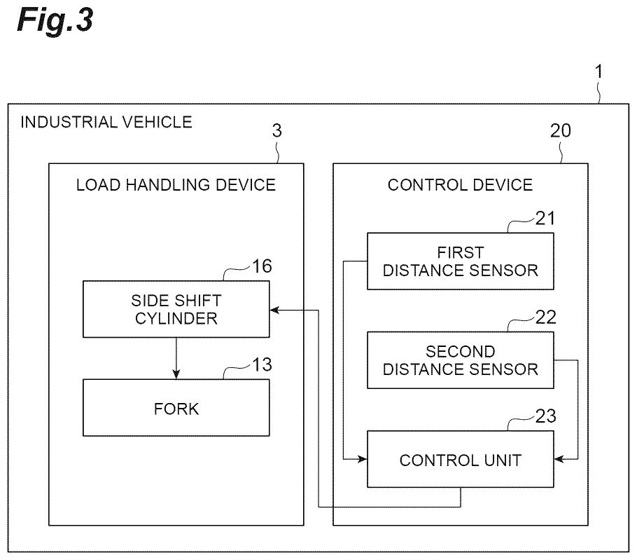

The load handling device 3 includes a mast 11, the pair of forks 13, the lift cylinder 14, the tilt cylinder 15, and a side shift cylinder 16 (see FIG. 3). The mast 11 is attached to the vehicle body 4. The pair of forks 13 are attached to the mast 11 by way of a lift bracket 12 to hold a load W. The lift cylinder 14 raises and lowers the fork 13. The tilt cylinder 15 tilts the mast 11. The side shift cylinder 16 shifts the fork 13 in the horizontal direction. In the present embodiment, the side shift cylinder 16 functions as a side shift mechanism that shifts the positions of the pair of forks 13 in the horizontal direction.

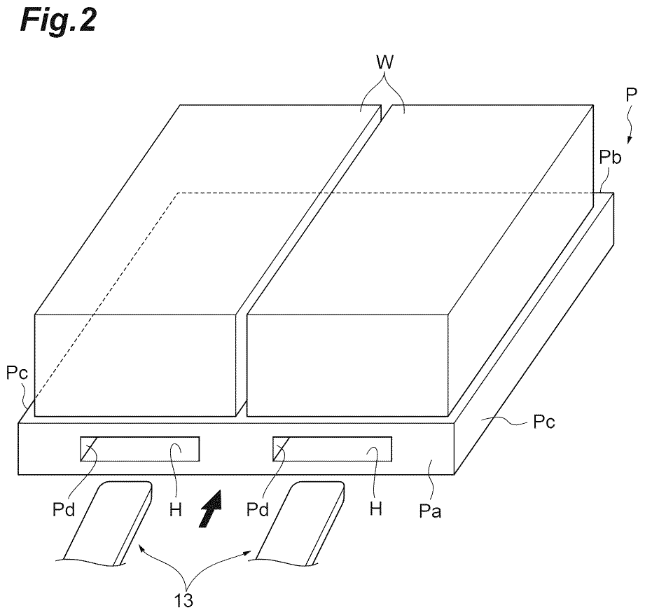

The industrial vehicle 1 is a self-propelled vehicle. The industrial vehicle 1 receives a pallet P at a load receiving position set at an arbitrary position indoors and outdoors, for example, and moves to a loading position where the pallet P is to be loaded. Then, the industrial vehicle 1 loads the pallet P at the loading position. FIG. 2 is a perspective view schematically illustrating a state when the industrial vehicle 1 performs load handling.

The pallet P is a load handling table for placing the load W, and is a load handling target on which a load handling operation is performed by the load handling device 3. As illustrated in FIG. 2, for example, one or a plurality of loads W is placed on the pallet P. The pallet P is, for example, a flat pallet made of plastic or wood. The pallet P has a rectangular shape in plan view.

The pallet P includes a front surface Pa, a rear surface Pb, and a pair of side surfaces Pc. The front surface Pa is a surface facing the industrial vehicle 1 when the pallet P is held by the forks 13. The rear surface Pb is a surface located on a side opposite to the front surface Pa. The pair of side surfaces Pc are surfaces that abut with the loaded pallet or the like when the pallet P is loaded.

The pallet P is provided with an insertion hole H into which the pair of forks 13 are inserted. In the present embodiment, the pallet P is provided with a pair of insertion holes H in correspondence with the pair of forks 13. The insertion hole H is a through-hole having a rectangular cross section that passes through from the front surface Pa to the rear surface Pb of the pallet P. The insertion hole H is defined by an inner wall surface Pd of the pallet P.

Note that in the following description, a pallet to be loaded by the industrial vehicle 1 from now is referred to as a “pallet P1”, and a pallet that is already loaded is referred to as a “pallet P2”. Here, for the sake of convenience, the description will be given assuming that the pallet P1 and the pallet P2 have the same configuration.

During the load handling operation, the industrial vehicle 1 holds the pallet P1 by inserting the pair of forks 13 into the insertion hole H described above. At this time, in the insertion hole H, the side surface 13a of the fork 13 and the inner wall surface Pd defining the insertion hole H face each other in the horizontal direction. When the pallet P1 is loaded, the side shift cylinder 16 automatically shifts the side of the pair of forks 13 to abut the pallet P1 and the loaded pallet P2 with each other, and the pallet P1 and the pallet P2 are loaded so as not to form a gap therebetween. At this time, if the side shift amount of the pair of forks 13 becomes excessive, the pallet P1 being loaded may hit the pallet P2. In this case, a frictional force when the pallet P1 slides on the fork 13 or a reaction force against a force by which the fork 13 presses the inner wall surface Pd of the pallet P1 defining the insertion hole H after the pallet P1 has hit the pallet P2 is applied to the fork 13, and a load may be applied to the mechanism on the fork 13 side.

In order to solve such a problem, the industrial vehicle 1 quickly detects sliding of the pallet P1 during the side shift operation, thereby preventing application on the forks 13 of a frictional force when the pallet P1 slides on the forks 13 or a reaction force against a force by which the forks 13 press the inner wall surface Pd of the pallet P1 after the pallet P1 has hit the pallet P2. In order to realize the function, the industrial vehicle 1 includes a control device 20.

Hereinafter, a functional configuration of the control device 20 for realizing the function will be described in detail. FIG. 3 is a block diagram illustrating an example of a functional configuration of the industrial vehicle. In order to realize the above-described functions, the control device 20 includes a first distance sensor 21, a second distance sensor 22, and a control unit 23.

The first distance sensor 21 and the second distance sensor 22 are distance sensors that detect a distance from the sensor itself to a detection object located in front of the sensor. For example, the first distance sensor 21 and the second distance sensor 22 detect the distance between themselves and the detection object by irradiating the front of themselves with laser light and receiving reflected light of the laser light from the detection object.

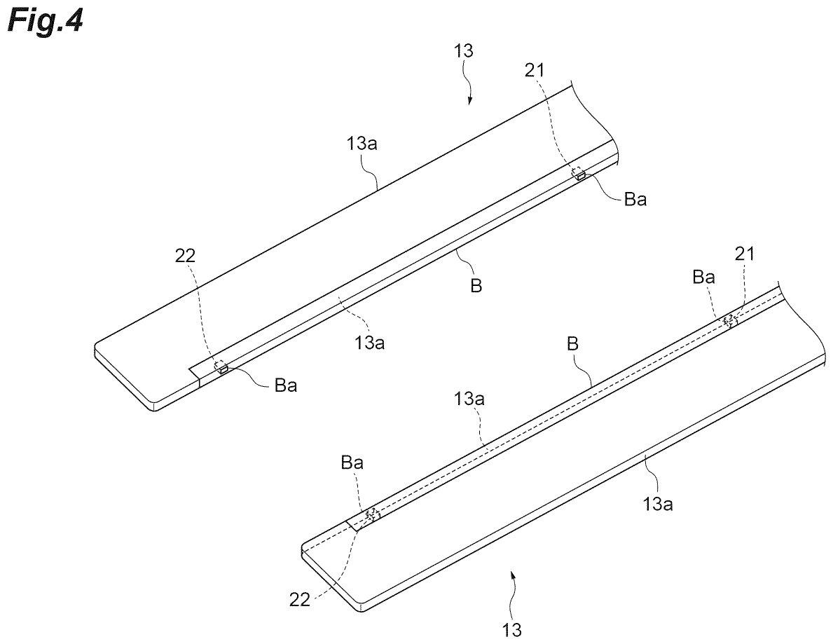

The first distance sensor 21 and the second distance sensor 22 are provided on the side surface 13a in the horizontal direction of each of the pair of forks 13. In the present embodiment, as illustrated in FIG. 4, in each of the pair of forks 13, the first distance sensor 21 is provided on a basal end side of the fork 13, and the second distance sensor 22 is provided on a distal end side of the fork. That is, in the present embodiment, the first distance sensor 21 and the second distance sensor 22 are provided at different positions from each other on the side surface 13a in an extending direction of the fork 13. On the side surface 13a, the first distance sensor 21 and the second distance sensor 22 may be embedded in the side surface 13a or may be provided on the side surface 13a.

In the pair of forks 13, the first distance sensor 21 and the second distance sensor 22 are provided on the respective side surfaces 13a of the pair of forks 13 in directions opposite to each other so as to face the counterpart side. The first distance sensor 21 and the second distance sensor 22 provided on one fork 13 and the first distance sensor and the second distance sensor 22 provided on the other fork face each other in the horizontal direction.

Furthermore, in the present embodiment, as illustrated in FIG. 4, a bracket B with a window is provided on the side surface 13a of each of the pair of forks 13. The bracket B is provided with two windows Ba. The window Ba is, for example, an opening provided in the bracket B. In the bracket B, the two windows Ba are provided at positions corresponding to the positions where the first distance sensor 21 and the second distance sensor 22 are provided. That is, the bracket B with the window is provided on the side surface 13a of the fork 13 so that the first distance sensor 21 and the second distance sensor 22 are exposed from the corresponding window Ba.

For example, in a state where the pair of forks 13 are inserted into the insertion hole H of the pallet P1, the side surface of the fork 13 and the inner wall surface Pd defining the insertion hole H face each other. Therefore, in this state, the detection object is the inner wall surface Pd of the pallet P1, and the first distance sensor 21 and the second distance sensor 22 detect the distance from the side surface 13a of the fork 13 to the inner wall surface Pd.

The control unit 23 is a portion that controls a side shift operation by the side shift cylinder 16 (side shift mechanism). In the present embodiment, the control unit 23 stores an initial value ds and starts and stops the side shift operation in order to control the operation. Hereinafter, the storage of the initial value ds and the control of the start and stop of the side shift operation, which are the processes performed by the control unit 23, will be described in detail.

First, the storage of the initial value ds will be described. The initial value ds is a distance between the side surface 13a and the inner wall surface Pd when the side shift operation by the side shift cylinder 16 is started. In one example, among the distances d1 and d2 received from the first distance sensor 21 and the second distance sensor 22, the control unit 23 stores, as the initial value ds, the distances d1 and d2 received when the side shift operation is started. In this case, when the side shift operation is started, the control unit 23 may store each distance received from the first distance sensor 21 and the second distance sensor 22 as the corresponding initial value ds, or may store any one distance as the initial value ds. Alternatively, the control unit 23 may store a value input in advance by the user using the industrial vehicle 1 as the initial value ds.

Next, control of start and stop of the side shift operation will be described. In the present embodiment, a start command is transmitted to the side shift cylinder 16 to control the start of the side shift operation, and a stop command is transmitted to control the stop of the side shift operation. The start command is a command for starting the side shift operation, and the stop command is a command for stopping the side shift operation. In one example, the control unit 23 stops the side shift operation by the side shift cylinder 16 based on the relationship between the distances d1 and d2 during the side shift operation and the initial value ds.

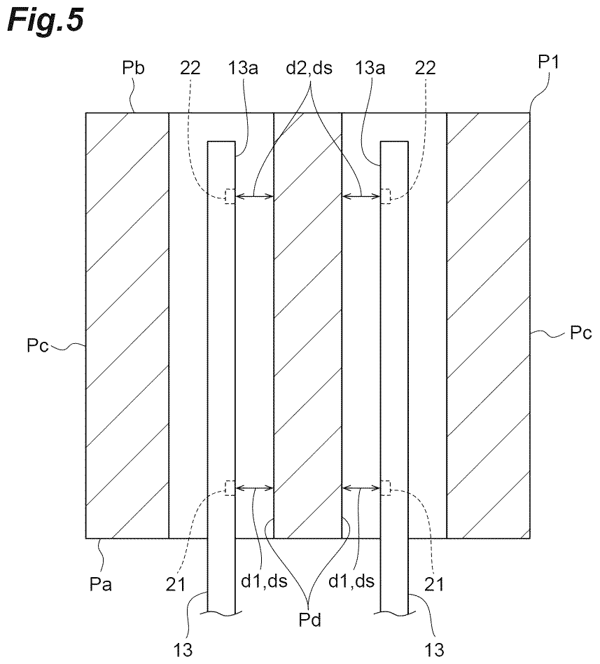

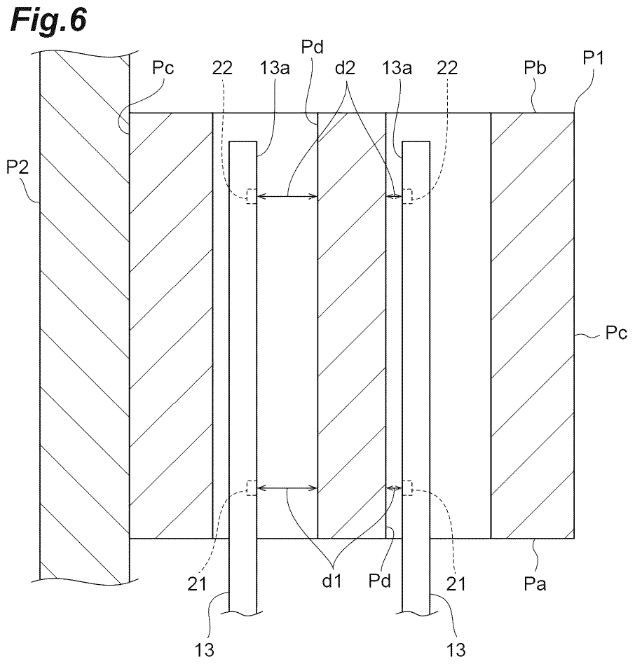

In the present embodiment, the control of stopping the side shift operation by the control unit 23 is performed, for example, when the fork 13 is inserted along the extending direction of the insertion hole H. Prior to describing a more specific process when stopping the side shift operation, the configuration of the fork 13 and the pallet P1 during the side shift operation in the above case will be described in detail with reference to FIGS. 5 and 6.

FIGS. 5 and 6 are cross-sectional views schematically illustrating configurations of the fork and the pallet. Specifically, FIG. 5 is a cross-sectional view schematically illustrating a configuration of the fork 13 and the pallet P1 when the side shift operation is started. FIG. 6 is a cross-sectional view schematically illustrating a configuration of the fork 13 and the pallet P1 when the pallet P1 abuts on the pallet P2. Note that in FIGS. 5 and 6, the configuration of the fork 13 is illustrated in a simplified manner, but is actually the same as the configuration illustrated in FIG. 4.

First, the distance between the side surface 13a and the inner wall surface Pd at each position will be described. As described above, when the fork 13 is inserted along the extending direction of the insertion hole H, the distance with the inner wall surface Pd is equal at any position of the side surface 13a.

Next, a change in the distance between the side surface 13a and the inner wall surface Pd during the side shift operation will be described. During the side shift operation, both the fork 13 and the pallet P1 shift in the horizontal direction during a period from a time point when the side shift operation is started to a time point when the pallet P1 held by the fork 13 and the pallet P2 abut with each other. As a result, in the above period, as illustrated in FIG. 5, the distance between the side surface 13a of the fork 13 and the inner wall surface Pd does not vary from the distance of when the side shift operation is started.

On the other hand, after the pallet P1 held by the fork 13 and the pallet P2 abut with each other, only the fork 13 slides in the horizontal direction in the insertion hole H. Specifically, as illustrated in FIG. 6, in the insertion hole H, the fork 13 slides toward the side surface Pc abutted on the pallet P2. As a result, the distance between the side surface 13a and the inner wall surface Pd increases in one fork 13 located on the side surface Pc side, and the distance between the side surface 13a and the inner wall surface Pd decreases in the other fork 13.

From the above, in a case where the fork 13 is inserted along the extending direction of the insertion hole H, the distances d1 and d2 detected by the first distance sensor 21 and the second distance sensor 22 provided in each of the pair of forks 13 become equal to each other in the period from the time point the side shift operation is started to the time point the pallet P1 and the pallet P2 are abutted with each other.

Similarly, after the pallet P1 and the pallet P2 are abutted with each other, the distance d1 detected by the first distance sensor 21 and the distance d2 detected by the second distance sensor 22 at one fork 13 on the side abutted on the pallet P2 become larger than the initial value ds, and the distance d1 and the distance d2 at the other fork 13 become smaller than the initial value ds.

In the present embodiment, the control unit 23 stops the side shift operation in view of the change in the distance between the side surface 13a of the fork 13 and the inner wall surface Pd during the side shift operation described above. That is, in the present embodiment, when the distance d1 and the distance d2 at the fork 13 on the side surface Pc side abutted on the pallet P2 of the pallet P1 become larger than the initial values ds and the distance d1 and the distance d2 at the other fork 13 become smaller than the initial values ds, the control unit 23 stops the side shift operation by the side shift cylinder 16.

Alternatively, when the distance d1 or the distance d2 at the fork 13 on the side surface Pc side abutted on the pallet P2 of the pallet P1 becomes larger than the initial value ds and the distance d1 or the distance d2 at the other fork 13 becomes smaller than the initial value ds, the control unit 23 may stop the side shift operation by the side shift cylinder 16.

As described above, the first distance sensor 21 and the second distance sensor 22 are provided on the side surface 13a of the fork 13. The detection objects of the first distance sensor 21 and the second distance sensor 22 are the inner wall surface Pd defining the insertion hole H. Therefore, the distances d1 and d2 detected by the first distance sensor 21 and the second distance sensor 22 are distances between the side surface 13a of the fork 13 and the inner wall surface Pd. As described above, when the distance between the side surface 13a of one fork 13 and the inner wall surface Pd is larger than the initial value ds and the distance between the side surface 13a of the other the forks 13 and the inner wall surface Pd is smaller than the initial value ds, the control unit 23 stops the side shift operation by the side shift cylinder 16.

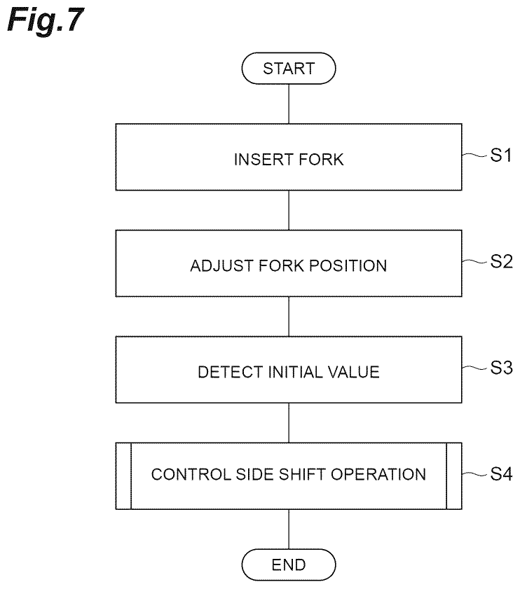

Next, an example of the operation of the industrial vehicle 1 will be described with reference to FIG. 7. FIG. 7 is a flowchart illustrating an example of an operation of the industrial vehicle 1.

In step S1, the fork 13 is inserted into the insertion hole H of the pallet P1. As a result, the pallet P1 is held by the fork 13. In step S2, the control unit 23 adjusts the fork position in the insertion hole H. Here, the fork position in the insertion hole H is adjusted based on the width of the fork 13 and the width of the insertion hole H so that the first distance sensor 21 and the second distance sensor 22 do not come into contact with the inner wall surface Pd of the pallet P1 during the side shift operation at the time of loading.

In step S3, the first distance sensor 21 and the second distance sensor 22 provided in each of the pair of forks 13 detect the distance (initial value ds) between the side surface 13a of the fork 13 and the inner wall surface Pd of when the side shift operation is started.

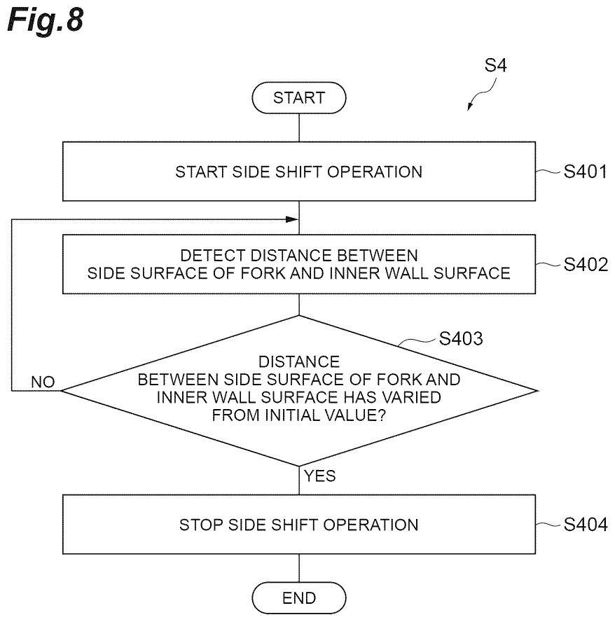

In step S4, the control unit 23 controls the side shift operation by the side shift cylinder 16. The control of the side shift operation by the control unit 23 in step S4 will be described in more detail with reference to FIG. 8. FIG. 8 is a flowchart illustrating an example of a control of the side shift operation.

In step S401, the control unit 23 starts the side shift operation by the side shift cylinder 16. Here, the control unit 23 starts the side shift operation by transmitting the start command for starting the side shift operation to the side shift cylinder 16.

In step S402, the first distance sensor 21 and the second distance sensor 22 provided in each of the pair of forks 13 detect the distances d1 and d2 between the side surface 13a of the fork 13 and the inner wall surface Pd.

In step S403, the control unit 23 determines whether or not the distances d1 and d2 between the side surface 13a of the fork 13 and the inner wall surface Pd detected in step S402 have varied from the initial value ds. Here, the control unit 23 determines whether or not the distance d1 and the distance d2 at one fork 13 have become larger than the initial value ds, and whether or not the distance d1 and the distance d2 at the other fork 13 have become smaller than the initial value ds.

In a case where the distance d1 and the distance d2 at one fork 13 have become larger than the initial values ds and the distance d1 and the distance d2 at the other fork 13 have become smaller than the initial values ds (YES in step S403), the process proceeds to step S404.

In a case where the distance d1 and the distance d2 at one fork 13 have not become larger than the initial values ds, or if the distance d1 and the distance d2 at the other fork 13 have not become smaller than the initial values ds (NO in step S403), the process returns to step S402.

In step S404, the control unit 23 stops the side shift operation by the side shift cylinder 16. Here, the control unit 23 stops the side shift operation by transmitting the stop command for stopping the side shift operation to the side shift cylinder 16.

As described above, in the industrial vehicle 1, the stop of the side shift operation by the side shift cylinder 16 (side shift mechanism) is determined by the relationship between the distances d1 and d2 between the side surface 13a of the fork 13 and the inner wall surface Pd of the pallet P1 and the initial value ds of the distances. During the side shift operation, both the fork 13 and the pallet P1 shift in the horizontal direction during a period from the start of the operation until the pallet P1 and the loaded pallet P2 abut on each other. Therefore, in the above period, the distances d1 and d2 detected by the first distance sensor 21 and the second distance sensor 22 do not vary from the initial value ds. On the other hand, after the pallet P1 and the loaded pallet P2 abut with each other, only the fork 13 slides in the horizontal direction in the insertion hole H, and thus the distances d1 and d2 detected by the first distance sensor 21 and the second distance sensor 22 vary from the initial value ds. Therefore, when the side shift operation is executed, the side shift operation is stopped in a case where the distances d1 and d2 between the side surface 13a of the fork 13 and the inner wall surface Pd of the pallet P1 are varied from the initial value ds, whereby sliding of the fork 13 in the insertion hole H can be promptly detected. As a result, it is possible to prevent the frictional force when the pallet P1 slides on the forks 13 or the reaction force against a force by which the forks 13 press the inner wall surface Pd of the pallet P1 after the pallet P1 hits the pallet P2 from being applied to the forks 13. As a result, an excessive load can be suppressed from being applied to the mechanism on the fork 13 side during the side shift operation.

In the industrial vehicle 1, the side shift amount is prevented from becoming excessive by stopping the side shift operation by the control described above. As a result, the time required for the side shift operation when loading one pallet P1 can be reduced as compared with the conventional time of loading. As a result, the time required for the load handling operation by the industrial vehicle 1 can be reduced.

In the industrial vehicle 1, the first distance sensor 21 and the second distance sensor 22 are provided on the respective side surfaces 13a of the pair of forks 13 in directions opposite to each other. In this case, the detection accuracy of sliding of the fork 13 in the insertion hole H can be improved.

In the industrial vehicle 1, the control unit 23 stops the side shift operation by the side shift cylinder 16 when the distance d1 and the distance d2 at one fork 13 become larger than the initial value ds and the distance d1 and the distance d2 at the other fork 13 become smaller than the initial value ds. After the pallet P1 being loaded abuts on the loaded pallet P2, the pallet P1 being loaded slides in one direction in the horizontal direction in the insertion hole H. At this time, accompanying sliding, the distance between the side surface 13a of one fork 13 and the inner wall surface Pd of the pallet P increases, and the distance between the side surface 13a of the other fork 13 and the inner wall surface Pd of the pallet P decreases. Therefore, the first distance sensor 21 and the second distance sensor 22 are provided on the respective side surfaces 13a of the pair of forks 13 in the directions opposite to each other, and the side shift operation is stopped as described above, so that sliding of the fork 13 in the insertion hole H can be accurately detected.

In the industrial vehicle 1, the control device 20 includes the first distance sensor 21 located on the basal end side of the fork 13 and the second distance sensor 22 located on the distal end side of the fork. In this case, sliding of the fork 13 in the insertion hole H can be accurately detected.

In the industrial vehicle 1, the first distance sensor 21 and the second distance sensor 22 are provided on the side surfaces 13a of the pair of forks 13 facing the counterpart fork 13. In this case, it is possible to prevent the first distance sensor 21 and the second distance sensor 22 from colliding with the inner wall surface Pd of the pallet P1 accompanying the side shift operation. Therefore, damage to the first distance sensor 21 and the second distance sensor 22 can be prevented.

In the industrial vehicle 1, the pair of forks 13 are provided with the bracket B with the window. The bracket B with the window is provided on the side surface 13a such that the first distance sensor 21 and the second distance sensor 22 are exposed from the window Ba. In this case, the bracket B protects the first distance sensor 21 and the second distance sensor 22 while easily realizing the configuration in which the first distance sensor 21 and the second distance sensor 22 are provided on the side surface 13a.

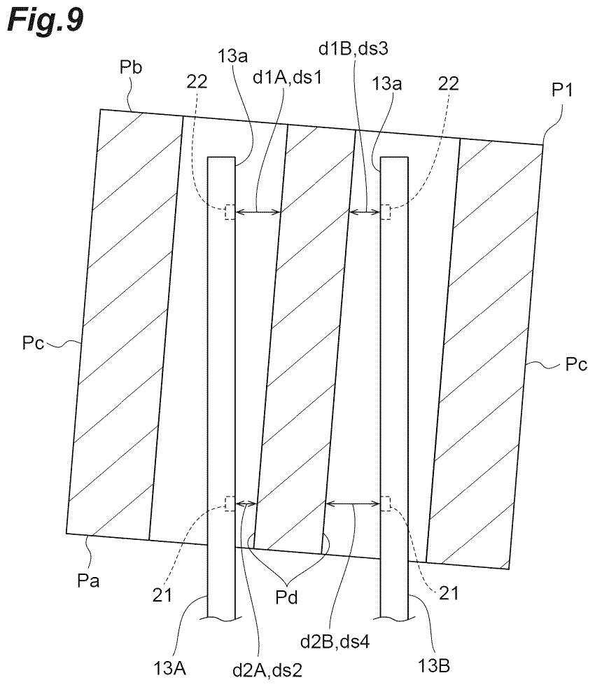

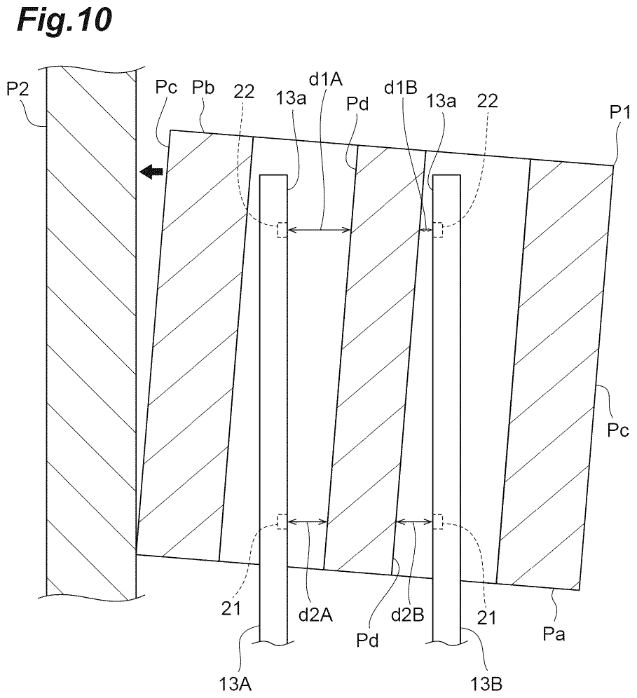

Next, a modified example of the control of the side shift operation by the control unit 23 will be described with reference to FIGS. 9 and 10. FIGS. 9 and 10 are cross-sectional views illustrating configurations of the fork and the pallet. Specifically, FIG. 9 is a cross-sectional view illustrating a configuration of the fork 13 and the pallet P1 when the side shift operation is started. FIG. 10 is a cross-sectional view illustrating a configuration of the fork 13 and the pallet P1 when the pallet P1 abuts on the pallet P2. Note that in FIGS. 9 and 10, the configuration of the fork 13 is illustrated in a simplified manner, but is actually the same as the configuration illustrated in FIG. 4.

In the present modified example, the control of the side shift operation by the control unit 23 is performed, for example, when the fork 13 is inserted obliquely with respect to the extending direction of the insertion hole H. Here, prior to the description of specific process of the control unit 23 in the present modified example, the configuration of the fork 13 and the pallet P1 during the side shift operation when the fork 13 is inserted obliquely with respect to the extending direction of the insertion hole H will be described in detail.

First, the distance between the side surface 13a and the inner wall surface Pd at each position will be described. When the fork 13 is inserted obliquely with respect to the extending direction of the insertion hole H, the distance between the side surface 13a and the inner wall surface Pd is not equal over the entire side surface 13a. That is, in the side surface 13a, the distance to the inner wall surface Pd is different for each position.

For example, in the example illustrated in FIG. 9, the distance to the inner wall surface Pd decreases toward the basal end side in one fork 13, and the distance to the inner wall surface Pd increases toward the basal end side in the other fork 13. In the following description, in order to distinguish the pair of forks 13, the fork 13 in which the distance between the side surface 13a and the inner wall surface Pd decreases toward the basal end side is referred to as a “fork 13A”, and the fork 13 in which the distance between the side surface 13a and the inner wall surface Pd increases toward the basal end side is referred to as a “fork 13B”.

Next, a change in the distance between the side surface 13a and the inner wall surface Pd during the side shift operation will be described. Even in a case where the forks 13A and 13B are inserted obliquely with respect to the extending direction of the insertion hole H as illustrated in FIG. 9, both the forks 13A and 13B and the pallet P1 are shifted in the horizontal direction in a period from a time point when the side shift operation is started until the pallet P1 held by the forks 13A and 13B is abutted on the loaded pallet P2. Therefore, in the above period, similarly to the case where the fork 13 is inserted along the extending direction of the insertion hole H, the distance between each of the side surfaces 13a of the forks 13A and 13B and the inner wall surface Pd does not vary from the initial value ds.

On the other hand, when the pallet P1 and the pallet P2 abut with each other, a part of the pallet P1 first abuts on the pallet P2. Specifically, a part of the side surface Pc of the pallet P1 abuts on the pallet P2. At this time, the distance between the portion closer to the part of the side surface Pc among the side surfaces 13a of the forks 13A and 13B and the inner wall surface Pd varies from the distance of when the side shift operation is started. Thereafter, as illustrated in FIG. 10, the pallet P1 is shifted so as to fill the gap between the remaining portion of the side surface Pc of the pallet P1 and the pallet P2. Then, after the entire side surface Pc of the pallet P1 and the pallet P2 abut with each other, the distance between the remaining portion of each side surface 13a of the forks 13A and 13B and the inner wall surface Pd varies from the distance of when the side shift operation is started, and the distance between the side surface 13a and the inner wall surface Pd becomes equal over the entire side surface 13a.

As described above, when the forks 13A and 13B are inserted obliquely with respect to the extending direction of the insertion hole H, the distances d1 and d2 detected by the first distance sensor 21 and the second distance sensor 22 provided in the pair of forks 13A and 13B are different from each other. Similarly, the initial value ds varies depending on the position of each distance sensor.

In the following description, in order to distinguish each distance d1, the distance d1 detected by the first distance sensor 21 provided on the fork 13A is referred to as “distance d1A”, and the distance d1 detected by the first distance sensor 21 provided on the fork 13B is referred to as “distance d1B”.

In order to distinguish each distance d2, the distance d2 detected by the second distance sensor 22 provided on the fork 13A is referred to as “distance d2A”, and the distance d2 detected by the second distance sensor 22 provided on the fork 13B is referred to as “distance d2B”.

In order to distinguish each initial value ds, the initial values ds at the positions where the first distance sensor 21 and the second distance sensor 22 are provided in the fork 13A are respectively referred to as “initial value ds1” and “initial value ds2”, and the initial values ds at the positions where the first distance sensor 21 and the second distance sensor 22 are provided in the fork 13B are respectively referred to as “initial value ds3” and “initial value ds4”.

In the fork 13A, one of the distances d1A and d2A varies from the corresponding initial values ds1 and ds2 when the part of the pallet P1 abuts on the pallet P2, and thereafter, the other varies from the corresponding initial values ds1 and ds2 when the remaining part of the pallet P1 abuts on the pallet P2, and finally, the distance d1A and the distance d2A become equal. In the fork 13B, the distances d1B and d2B change, similarly to the fork 13A.

In the present modified example, the control unit 23 controls the side shift operation in view of the change in the distance between the side surface 13a of the forks 13A and 13B and the inner wall surface Pd when the forks 13A and 13B are inserted obliquely with respect to the extending direction of the insertion hole H described above.

Specifically, the control unit 23 stops the side shift operation by the side shift cylinder 16 when a predetermined time has elapsed after one of the distances d1A and d2A has varied from the corresponding initial values ds1 and ds2 and one of the distances d1B and d2B has varied from the corresponding initial values ds3 and ds4.

Alternatively, the control unit 23 may stop the side shift operation of the side shift cylinder 16 when the predetermined time has elapsed after one of the distances d1A and d2A has varied from the corresponding initial values ds1 and ds2, or when the predetermined time has elapsed after one of the distances d1B and d2B has varied from the corresponding initial values ds3 and ds4.

The predetermined time is determined based on the speed of the fork 13 shifted by the speed of the side shift operation. The predetermined time is set in consideration of the speed of the side shift operation, and a range thereof is, for example, greater than or equal to 0.5 seconds and less than or equal to 3.0 seconds. The gap between the pallet P1 and the pallet P2 can be brought close to 0 as much as possible by setting the predetermined time to greater than or equal to 0.5 seconds. Furthermore, in the course of the side shift operation, when the side shift amount in the operation becomes a maximum, even in a case where the pallet P1 and the pallet P2 are not abutted with each other, the loading of the pallet P1 may be started. In such a case, by setting the predetermined time to less than or equal to 3.0 seconds, the side shift operation is stopped before the side shift amount becomes the maximum, and the pallet P1 can be prevented from being loaded in a state where the pallet P1 and the pallet P2 are not abutted with each other.

The speed of the side shift operation includes, for example, the shift speed of the fork 13 during the side shift operation. Therefore, the predetermined time may be set in consideration of the shift speed of the fork 13 during the side shift operation.

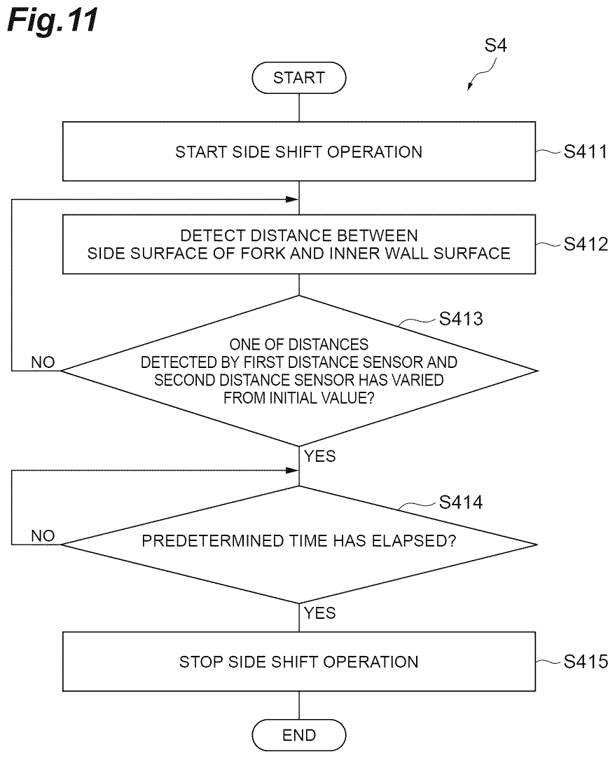

Next, control of the side shift operation by the control unit 23 in step S4 in the present modified example will be described with reference to FIG. 11. FIG. 11 is a flowchart illustrating another example of a control of the side shift operation.

In step S411, similarly to step S401, the control unit 23 starts the side shift operation by the side shift cylinder 16. In step S412, the first distance sensor 21 and the second distance sensor 22 provided in each of the pair of forks 13A and 13B detect the distances d1A, d1B, d2A, and d2B between the side surface 13a of the fork 13 and the inner wall surface Pd.

In step S413, the control unit 23 determines whether or not one of the distances d1A and d2A has varied from the corresponding initial values ds1 and ds2 and one of the distances d1B and d2B has varied from the corresponding initial values ds3 and ds4.

In a case where one of the distances d1A and d2A has varied from the corresponding initial values ds1 and ds2 and one of the distances d1B and d2B has varied from the corresponding initial values ds3 and ds4 (YES in step S413), the process proceeds to step S414.

When one of the distances d1A and d2A has not varied from the corresponding initial values ds1 and ds2 or when one of the distances d1B and d2B has not varied from the corresponding initial values ds3 and ds4 (NO in step S413), the process returns to step S412.

In step S414, the control unit 23 determines whether or not the predetermined time has elapsed since one of the distances d1A and d2A has varied from the corresponding initial values ds1 and ds2 and one of the distances d1B and d2B has varied from the corresponding initial values ds3 and ds4.

When the predetermined time has elapsed (YES in step S414), the process proceeds to step S415. When the predetermined time has not elapsed (NO in step S414), the process returns to step S414. That is, in the present modified example, the control unit 23 does not proceed the process until elapse of the predetermined time after one of the distances d1A and d2A has varied from the corresponding initial values ds1 and ds2 and one of the distances d1B and d2B has varied from the corresponding initial values ds3 and ds4.

In step S415, similarly to step S404, the control unit 23 stops the side shift operation by the side shift cylinder 16.

In the present modified example, the control unit 23 stops the side shift operation by the side shift cylinder 16 when the predetermined time has elapsed after one of the distances d1A and d2A has varied from the corresponding initial values ds1 and ds2 and one of the distances d1B and d2B has varied from the corresponding initial values ds3 and ds4. According to such control, the excessive load can be suppressed from being applied to the mechanism on the fork 13 side during the side shift operation while arranging the pallet P1 with respect to the pallet P2 without the gap by setting the predetermined time in consideration of the speed of the side shift operation.

Next, another modified example of the control of the side shift operation by the control unit 23 will be described. The control of the side shift operation by the control unit 23 in the present modified example is also performed, for example, when the forks 13A and 13B are inserted obliquely with respect to the extending direction of the insertion hole H.

In this case, as described above, in the fork 13A, one of the distances d1A and d2A varies from the corresponding initial values ds1 and ds2 when the part of the pallet P1 abuts on the pallet P2. Thereafter, when the remaining part of the pallet P1 abuts on the pallet P2, the other varies from the corresponding initial values ds1 and ds2. Eventually, the distance d1A and the distance d2A become equal. The fork 13B is similar to the fork 13A.

Therefore, in the present modified example, the control unit 23 stops the side shift operation by the side shift cylinder 16 in a case where the distance d1A becomes equal to the distance d2A and the distance d1B becomes equal to the distance d2B after one of the distances d1A and d2A has varied from the corresponding initial values ds1 and ds2 and one of the distances d1B and d2B has varied from the corresponding initial values ds3 and ds4. Here, “equal” does not necessarily only mean that the values coincide with each other. Even when a slight difference or a measurement error within a preset range is included in the value, it may be considered as “equal”.

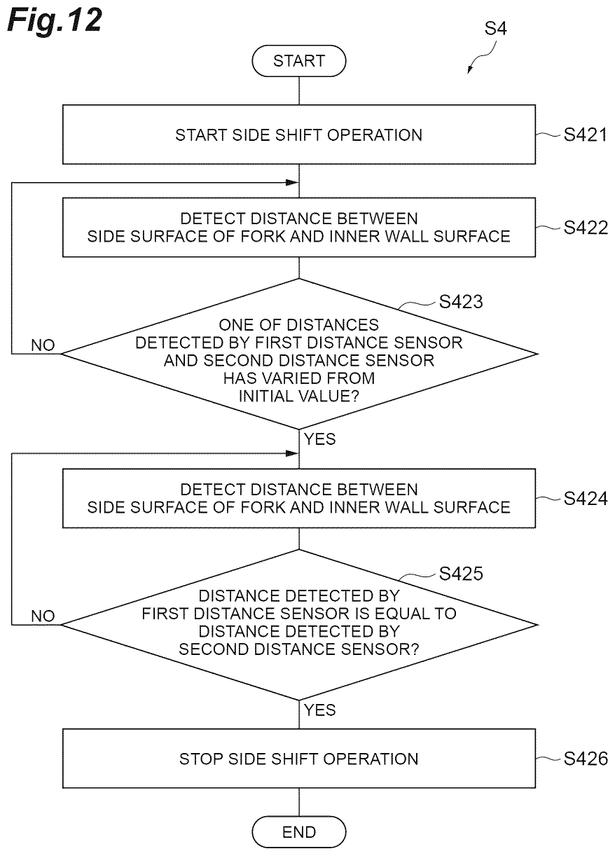

Next, control of the side shift operation by the control unit 23 in step S4 in the present modified example will be described with reference to FIG. 12. FIG. 12 is a flowchart illustrating another further example of a control of the side shift operation.

In step S421, similarly to step S401, the control unit 23 starts the side shift operation by the side shift cylinder 16. In step S422, the first distance sensor 21 and the second distance sensor 22 provided in each of the pair of forks 13A and 13B detect the distances d1A, d1B, d2A, and d2B between the side surface 13a of the fork 13 and the inner wall surface Pd, similarly to step S412 described above.

In step S423, the control unit 23 determines whether or not one of the distances d1A and d2A has varied from the corresponding initial values ds1 and ds2 and one of the distances d1B and d2B has varied from the corresponding initial values ds3 and ds4.

In a case where one of the distances d1A and d2A has varied from the corresponding initial values ds1 and ds2 and one of the distances d1B and d2B has varied from the corresponding initial values ds3 and ds4 (YES in step S423), the process proceeds to step S424.

When one of the distances d1A and d2A has not varied from the corresponding initial values ds1 and ds2 or when one of the distances d1B and d2B has not varied from the corresponding initial values ds3 and ds4 (NO in step S423), the process returns to step S422.

In step S424, the first distance sensor 21 and the second distance sensor 22 provided in each of the pair of forks 13A and 13B detect the distances d1A, d1B, d2A, and d2B between the side surface 13a of the fork 13 and the inner wall surface Pd, similarly to step S422 described above.

In step S425, the control unit 23 determines whether or not the distance d1A is equal to the distance d2A and whether the distance d1B is equal to the distance d2B. When the distance d1A and the distance d2A are equal and the distance d1B and the distance d2B are equal (YES in step S425), the process proceeds to step S426. When the distance d1A and the distance d2A are not equal or the distance d1B and the distance d2B are not equal (NO in step S425), the process returns to step S424.

In step S426, similarly to step S404, the control unit 23 stops the side shift operation by the side shift cylinder 16.

Therefore, in the present modified example, the control unit 23 stops the side shift operation by the side shift cylinder 16 in a case where the distance d1A becomes equal to the distance d2A and the distance d1B becomes equal to the distance d2B after one of the distances d1A and d2A has varied from the corresponding initial values ds1 and ds2 and one of the distances d1B and d2B has varied from the corresponding initial values ds3 and ds4. When the fork 13 is inserted obliquely with respect to the extending direction in the insertion hole H, as described above, the part of the pallet P1 being loaded abuts on the previously loaded pallet P2. At this time, among the distances d1A and d1B and the distances d2A and d2B, the distance detected by one distance sensor located closer to the part varies from the corresponding initial values ds1 to ds4. Thereafter, when the other portion of the pallet P1 abuts on the pallet P2, the distance d1A and the distance d2A become equal, and the distance d1B and the distance d2B become equal. Therefore, according to the control as described above, when the fork 13 is inserted obliquely with respect to the extending direction of the insertion hole H, the side shift operation can be stopped at the time point the pallet P1 abuts on the pallet P2. Therefore, the excessive load can be suppressed from being applied to the fork-side mechanism during the side shift operation while arranging the pallet P1 without the gap with respect to the pallet P2.

Although the embodiment and each modified example of the present disclosure have been described above, the present disclosure is not necessarily limited to the above-described embodiment and each modified example, and various modifications can be made without departing from the gist of the present disclosure.

The control for stopping the side shift operation by the side shift cylinder 16 is not limited to the above-described control. For example, the control unit 23 may stop the side shift operation by the side shift cylinder 16 when one of the distances d1 and d2 detected by the first distance sensor 21 and the second distance sensor 22 provided in each of the pair of forks 13 has varied from the initial value ds. In this case, sliding of the fork 13 in the insertion hole H can be detected with higher accuracy by stopping the side shift operation as described above.

Alternatively, the control unit 23 may stop the side shift operation by the side shift cylinder 16 when both of the distances d1 and d2 detected by the first distance sensor 21 and the second distance sensor 22 provided in each of the pair of forks 13 have varied from the initial value ds. In this case, the excessive load can be suppressed from being applied to the mechanism on the fork 13 side during the side shift operation while arranging the pallet P1 being loaded without the gap with respect to the loaded pallet P2.

In the above-described embodiment and each modified example, the first distance sensor 21 and the second distance sensor 22 are provided in each of the pair of forks 13, but the first distance sensor 21 and the second distance sensor 22 may be provided only in one fork 13 of the pair of forks 13. In this case, the control unit 23 may stop the side shift operation by the side shift cylinder 16 in a case where one of the distances d1 and d2 detected by the first distance sensor 21 and the second distance sensor 22 provided in the one fork 13 has varied from the initial value ds. Alternatively, the control unit 23 may stop the side shift operation by the side shift cylinder 16 in a case where both of the distances d1 and d2 detected by the first distance sensor 21 and the second distance sensor 22 provided in one of the forks 13 have varied from the initial value ds.

In the above-described embodiment and each modified example, the first distance sensor 21 and the second distance sensor 22 are provided in each of the pair of forks 13, but only one distance sensor may be provided in each of the pair of forks 13. In this case, the control unit 23 may stop the side shift operation by the side shift cylinder 16 in a case where the distance detected by the one distance sensor provided on the one fork 13 becomes larger than the initial value ds and the distance detected by the one distance sensor provided on the other fork 13 becomes smaller than the initial value ds.

Alternatively, one distance sensor may be provided only on one fork 13 of the pair of forks 13. In this case, the control unit 23 may stop the side shift operation by the side shift cylinder 16 in a case where the distance detected by the one distance sensor has varied from the initial value ds.

What is claimed is:

1. An industrial vehicle including a load handling device including a pair of forks and performing load handling by inserting the pair of forks into an insertion hole of a pallet, the industrial vehicle comprising:
a side shift mechanism configured to side shift positions of the pair of forks in a horizontal direction;
a distance sensor provided on a side surface of at least one of the pair of forks in the horizontal direction and configured to detect a distance from the side surface to a detection object; and
a control unit configured to control a side shift operation of the pair of forks by the side shift mechanism based on a detection result of the distance sensor, wherein
the control unit
stores an initial value of a distance between the side surface of the fork and an inner wall surface defining the insertion hole when the side shift operation by the side shift mechanism is started, and
stops the side shift operation by the side shift mechanism when the distance between the side surface of the fork and the inner wall surface has varied from the initial value during execution of the side shift operation by the side shift mechanism.

2. The industrial vehicle according to claim 1, wherein the distance sensors are provided on respective side surfaces of the pair of forks in directions opposite to each other.

3. The industrial vehicle according to claim 2, wherein the control unit stops the side shift operation by the side shift mechanism when a distance detected by a distance sensor of one fork becomes larger than the initial value and a distance detected by a distance sensor of the other fork becomes smaller than the initial value.

4. The industrial vehicle according to claim 1, wherein the distance sensor includes a first distance sensor located on a basal end side of the fork and a second distance sensor located on a distal end side of the fork.

5. The industrial vehicle according to claim 4, wherein the control unit stops the side shift operation by the side shift mechanism when one of distances detected by the first distance sensor and the second distance sensor has varied from the initial value.

6. The industrial vehicle according to claim 4, wherein the control unit stops the side shift operation by the side shift mechanism when both of distances detected by the first distance sensor and the second distance sensor have varied from the initial value.

7. The industrial vehicle according to claim 4, wherein the control unit stops the side shift operation by the side shift mechanism when a predetermined time has elapsed after one of distances detected by the first distance sensor and the second distance sensor has varied from the initial value.

8. The industrial vehicle according to claim 4, wherein the control unit stops the side shift operation by the side shift mechanism when a distance detected by the first distance sensor and a distance detected by the second distance sensor become equal after one of the distances detected by the first distance sensor and the second distance sensor has varied from the initial value.

9. The industrial vehicle according to claim 1, wherein the distance sensor is provided on a side surface of the pair of forks facing a counterpart fork.

10. The industrial vehicle according to claim 1, wherein
the pair of forks are each provided with a bracket with a window, and
the bracket with the window is provided on the side surface such that the distance sensor is exposed from the window.
